(19) United States
(12) Patent Application Publication
(10) Pub. No.: US 2015/0311996 A1
(43) Pub. Date: Oct. 29, 2015

(54) SYSTEMS AND METHODS FOR GLOBAL SPECTRAL EQUALIZATION

(71) Applicants: Juliano Rodrigues Fernandes de Oliveira, Campinas (BR); Eduardo Cavalcanti Magalhaes, Campinas (BR)

(72) Inventors: Juliano Rodrigues Fernandes de Oliveira, Campinas (BR); Eduardo Cavalcanti Magalhaes, Campinas (BR)

(73) Assignee: FUNDACAO CPQD - CENTRO DE PESQUISA E DESENVOLVIMENTO EM TELECOMUNICACOES, Campinas (BR)

(21) Appl. No.: 14/280,981

(22) Filed: May 19, 2014

(30) Foreign Application Priority Data
Nov. 26, 2013 (BR) 1020130302619

(51) Int. Cl. H04J 14/02

(52) U.S. Cl. CPC H04J 14/0215

(57) ABSTRACT

Systems and methods are disclosed for global spectral equalization. For example, a global spectral equalization method is disclosed that includes computing a reconfigurable optical add-drop multiplexer attenuation vector sum. The method also includes computing a residual tilt based on a level of channel warping. In addition, the method also includes computing an unnecessary attenuation based on the attenuation vector sum and the residual tilt. In addition, the method also includes distributing attenuation adjustment to nodes between a receiver and a transmitter based on the unnecessary attenuation.

### RELATED APPLICATIONS

This application claims priority to Brazilian application no. BR 10 2013 030261 9, filed Nov. 26 2013.

### TERMINOLOGY

This application refers to the following acronyms, expressions and terms:

BER—Bit Error Rate;

CAPEX—Capital Expenditure;

DP-QPSK—Dual Polarization-Quadriphase Shift Keying;

DWDM—Dense Wavelength Division Multiplexing;

EDFA—Erbium Doped Fiber Amplifier;

FEC—Forward Error Correction;

GFF—Gain Flattening Filter;

OSNR—Optical Signal to Noise Ratio;

PM-QPSK—Dual Polarization Quadriphase Shift Keying;

ROADM—Reconfigurable Optical Add-Drop Multiplexer;

STD-SMF—Standard Single Mode Optical Fiber;

WSS—Wavelength Selective Switch.

### APPLICATION FIELD

This application relates to the field of telecommunications and, more specifically, optical fiber communications. For example, a global power equalization method is disclosed that, applied in a DWDM optical communications system, can improve the quality of signal performance.

One or more of the disclosed embodiments may include a global power equalization method in an optical communication system/link to improve transmitted signals performance to:
provide greater spectral uniformity at the end of optical communication links, by controlling the spectral attenuation of optical routers;
provide improved OSNR for transmitted signals;
reduce total spectral attenuation imposed on signals;
reduce cascaded link noise; and
provide improved global results.

To meet needs in the telecommunications field, a “GLOBAL SPECTRAL EQUALIZATION METHOD APPLIED TO RECONFIGURABLE OPTICAL ADD-DROP MULTIPLEXER TO MAXIMIZE DWDM OPTICAL COMMUNICATION SYSTEM PERFORMANCE” has been developed, which provides spectral attenuation control of optical routers, allied with the transmitted signals performance maximization.

### BACKGROUND

Reconfigurable optical network evolution is directly related to the Reconfigurable Optical Add-Drop Multiplexer (ROADM) appearance and evolution. Current ROADM technology is based on wavelength selective switches (WSS). This allows optical channels to be reconfigured at any one of the switch output ports, and the channel associated with this port can also be equalized/attenuated.

The use of Reconfigurable Optical Add-Drop Multiplexers (ROADM) provides greater flexibility, allows networks to be remotely adjusted on demand, according to eventual changes in traffic and route, thus minimizing associated operational costs.

In general terms, considering reconfigurable optical networks' dynamic panorama, the number of wavelengths used on optical network nodes and optical amplifiers may vary (e.g., may be random), turning random the input power fluctuation at amplifiers (e.g., erbium doped fiber amplifiers (EDFA)) used along the network.

Under these conditions, due to the characteristics of the EDFA, the gain profile, already far from uniform, suffers considerable alterations as well, according to the input power fluctuation at the reconfigurable optical network. EDFA input power fluctuation thus results in gain spectral profile variations.

EDFA features a strong gain dependency related to input channel wavelength load throughout it amplification band, and the behavior of this dependency varies according to the input and pump power level that the amplifier is operating at. In this context, the EDFA is a significant network element, causing amplified spectral channel tilt in an optical system. This becomes even more relevant considering the cascade of amplifiers where channels travel through. In short, this characteristic can lead to the lack of power or excessive power in the optical channel after going through several EDFAs, causing a breakdown in system reception. Thus it is highly recommended to use ROADMs internal per channels attenuators or a similar device to equalize channels spectrum along the network.

There are several different approaches to be found in technical literature as to how channel power equalization can be achieved, including the use of dynamic optical filters at amplifier outputs, the use of multiplexers, demultiplexers and attenuators, or even the use of wavelength selective switches. The state of the art also includes methods and techniques for optical communication system power equalization.

Embodiments of the present disclosure may include a unique control method that address one or more of the following objectives:
provide a spectral attenuation control method for optical communication link ROADMs to increase spectral uniformity at the end of the link;
create a method that will provide improved OSNR for transmitted signals;
create a method that will reduce total spectral attenuation imposed on signals;
create a method that will reduce the total noise figure of the link; and
provide an algorithm that, considering simulation and experimental scenarios, will present better global link performance.

These objectives may be achieved through a spectral attenuation control method for optical communication link ROADMs where, since node equalization of a network with WSS is required, no additional devices will be needed and increased capital expenditure (CAPEX) for the link will be avoided.

### BRIEF DESCRIPTION OF THE FIGURES

The following figures have been attached and constitute a part of the disclosure:

FIG. 1 is a flowchart illustrating global spectral attenuation control.

FIG. 2 illustrates an experimental setup comprising a DP-QPSK optical transmitter, a 4 ROADM node optical link and 150 Km of STD-SMF, and a DP-QPSK optical receiver, besides the centralized controller, in an interrupted line, with access to the parameters of the devices.

FIG. 3a shows an experimental diagram of local spectral attenuation for a 3 WSS link.

FIG. 3b shows an experimental diagram of global attenuation for the equalization process, optimized global attenuation for the first iteration and in the permanent region, respectively.

FIG. 3c shows an experimental diagram of the OSNR of 80 channels modulated with 100 Gbps DP-QPSK for local equalization, global equalization with maximum attenuation per channel limited to 15 dB, global equalization with maximum attenuation divided equally between the three nodes and lastly, maximum global attenuation limited to 50% of total attenuation.

FIG. 3d shows an experimental diagram of the bit error rate (BER) of 80 channels modulated with DP-QPSK for local equalization, global equalization with maximum attenuation limited to 15 dB, global equalization with maximum attenuation divided equally between the three nodes and lastly, maximum global attenuation limited to 50% of total attenuation.

### DETAILED DESCRIPTION

The following detailed description should be read and interpreted with reference to the process flowcharts and block diagrams, representing the preferred form for the global spectral attenuation control method for optical communication link ROADMs, with no intention of limiting the scope of the disclosure, which has been clearly laid out in the claims section.

Some of the disclosed embodiments were implemented in an experimental setup with at least 80 channels, totaling a system of at least 150 kilometers and 4 WSSs. The results show that the proposed method has an OSNR gain of 6 dB and may be used in DWDM optical systems that use WSS to equalize channel power.

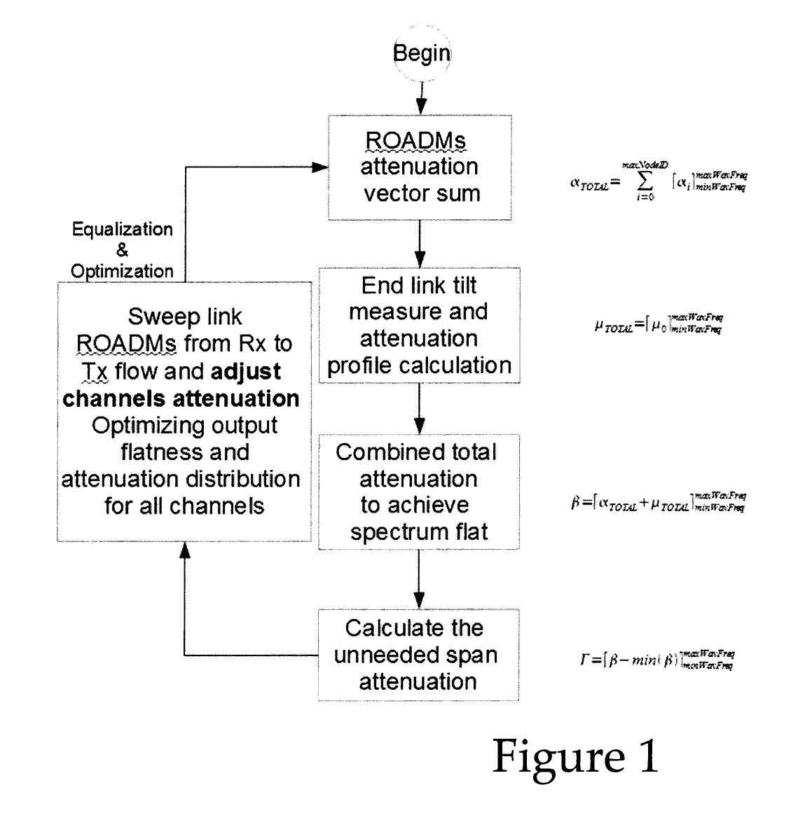

Some of the embodiments described herein are directed to a global spectral attenuation control method for optical communication link ROADMs. FIG. 1 depicts one exemplary global spectral attenuation control method that may be implemented, for example, using software, hardware, or a combination of software and hardware. For example, software stored in a non-transitory computer-readable medium (e.g., ROM, RAM, hard disk, and the like) may be executed by one or more computer processors to perform the operations described in FIG. 1. The method described in FIG. 1 may be implemented, for example, in an optical system that includes one or more transmitters (e.g., DP-QPSK optical transmitters), one or more wavelength selective switches, one or more amplifiers (e.g., EFDAs), one or more receivers (e.g., DP-QPSK optical receivers), and one or more optical fiber cables. In some embodiments, the term “node” may refer to any component in an optical system, such as, for example, a transmitter, wavelength selective switch, amplifier, or receiver. In other embodiments, the term “node” may only refer to components, such as the wavelength selective switches and/or amplifiers, between the transmitter and the receiver. The method described in FIG. 1 may include, for example:

Step 1: computing a ROADM attenuation vector sum. For example, a computer system, which may be, or may be connected to, a ROADM, may be connected to a plurality of nodes in an optical system. The computer system may be configured to measure one or more parameters of one or more of the nodes of the optical system, and may also be configured, as described in more detail below, to calibrate the one or more nodes. The computer system may be configured to determine a global attenuation vector (αTOTAL) by calculating a sum of all attributed attenuations (αi) for each frequency (minFreq-maxFreq) at each node (i) until the last node (maxNodelD), as defined by the equation:

$${α}_{TOTAL} = {\sum }_{i = 0}^{maxNodeID} {[ α i ]}_{minFreq }^{maxFreq}$$

Step 2: computing residual tilt (μTOTAL) in the reception (e.g., the output of the receiver). For example, the computer system may be configured to determine a level of channel warping (μ0) defined by the equation:

μ_{TOTAL}=[μ₀]_{minFreq}^{maxFreq}

Step 3: computing the attenuation profile sum+residual tilt (β), which is given throughout the entire equalization process. For example, the computer system may be configured to calculate the sum by performing the following calculation:

β=[α_{TOTAL}+μ_{TOTAL}]_{minFreq}^{maxFreq}

Step 4: computing unnecessary attenuation. For example, the computer system may be configured, once the attenuation profile sum+residual tilt (β) has been computed, to compute the attenuation needed in the global equalization process (Γ) by performing the following calculation:

Γ=[β−min(β)]_{minFreq}^{maxFreq}

After determining the value of Γ (e.g., in dB), the computer system may be configured to normalize the total loss needed to equalize the optical link. The normalized value of Γ represents the spectral attenuation to be applied to the optical communication system to increase spectrum uniformity at the end of the link.

Step 5: distributing attenuation adjustment from the receiver to the transmitter. In other words, the attenuation profile may be applied to the system. In some embodiments, the attenuation distribution must be optimized across the nodes of the system by, for example, minimizing noise (NF) of the system as a whole. Total noise (NFTotal) of a cascaded DWDM system (NF1, NF2 . . . NFm) may be computed by the equation:

$${NF}_{Total} = \frac{{NF}_{1}}{{α}_{1}} + \frac{{NF}_{2}}{{α}_{1} {G}_{1} {α}_{2}} + … + \frac{{NF}_{m}}{{α}_{m} {\prod }_{k = 1}^{m - 1} {G}_{k} {α}_{k}}$$

According to the equation above, the first nodes of a cascade in an optical link have a greater impact on total link noise (NFTotal). Thus, optical link noise may be improved using the spectral attenuation optimization rule applied to a channel across the optical link ROADMs:
after determining the normalized Γ, needed spectral attenuation may be applied, for example by the computer system, from the last node to the first node;
as much spectral attenuation as possible may be applied, for example by the computer system, to the last node, limited to the maximum attenuation allowed by the WSS ROADM; and any residual attenuation may be applied to the subsequent nodes, (in the WSS ROADMs) in a direction inverse to that traveled by signal propagation.

In some embodiments, this process will run in a loop, to ensure dynamic equalization even when system conditions change spuriously.

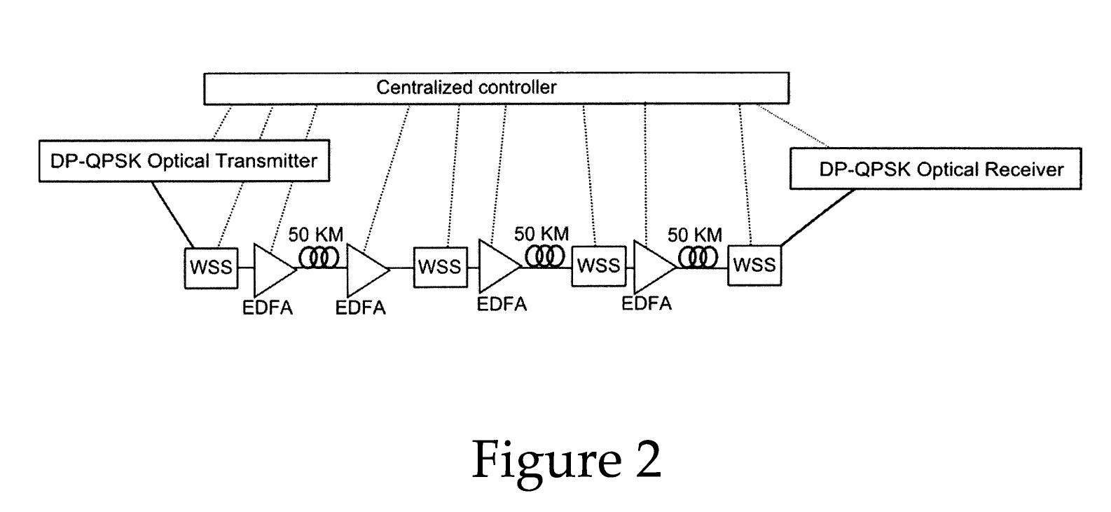

FIG. 2 depicts one example arrangement using DP-QPSK modulation formats with 112 Gb/s transmission rates.

In the example shown in FIG. 2, the optical quadrature modulator with polarization diversity (PM-QPSK) is fed by four binary lines at 28 Gb/s in a sequence of pseudorandom 5th-order bits and modulated in 80 DWDM channels.

The exemplary arrangement shown in FIG. 2 may include 4 WSS and 3 50-km standard monomode fiber (STD-SMF) links. EDFAs may be used to compensate total system loss. Each link may be balanced to work at maximum power: 0 dBm per channel.

In one experiment, at the end of the receiver, with phase and polarization diversity, the electric output signals were acquired 40,000 samples with a real time oscilloscope for each electric line from XYIQ to 40 million samples per second. Data was processed offline by digital signal processing algorithms.

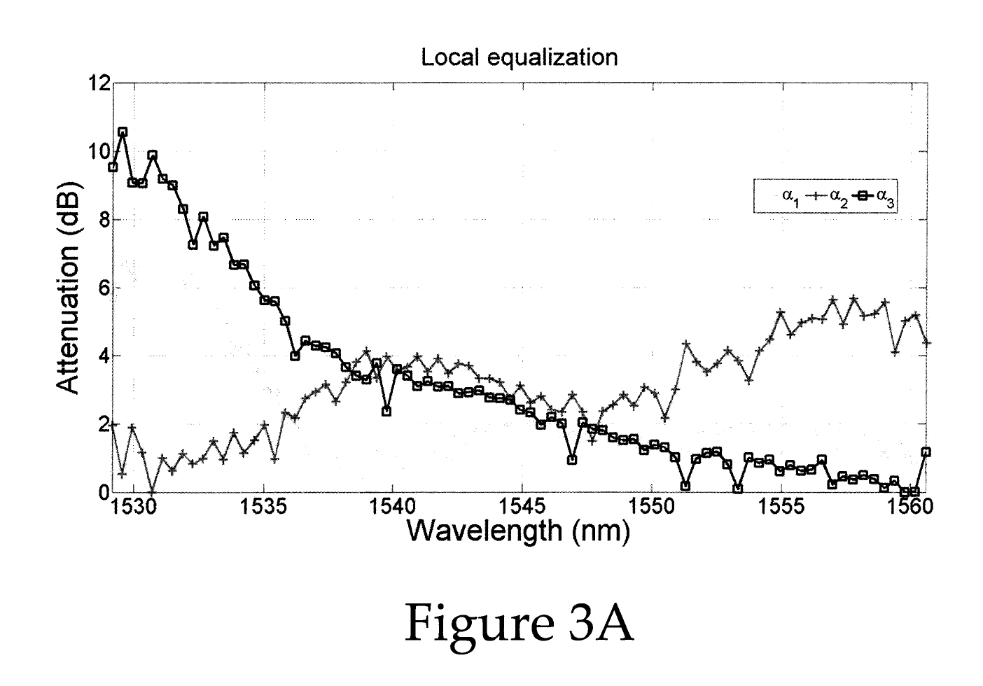

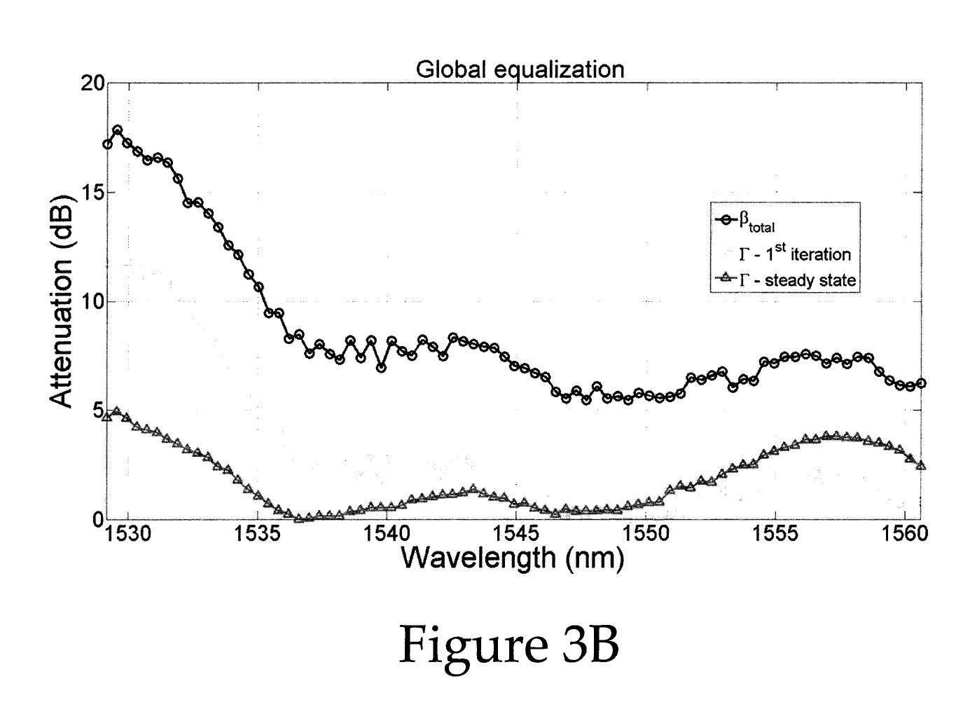

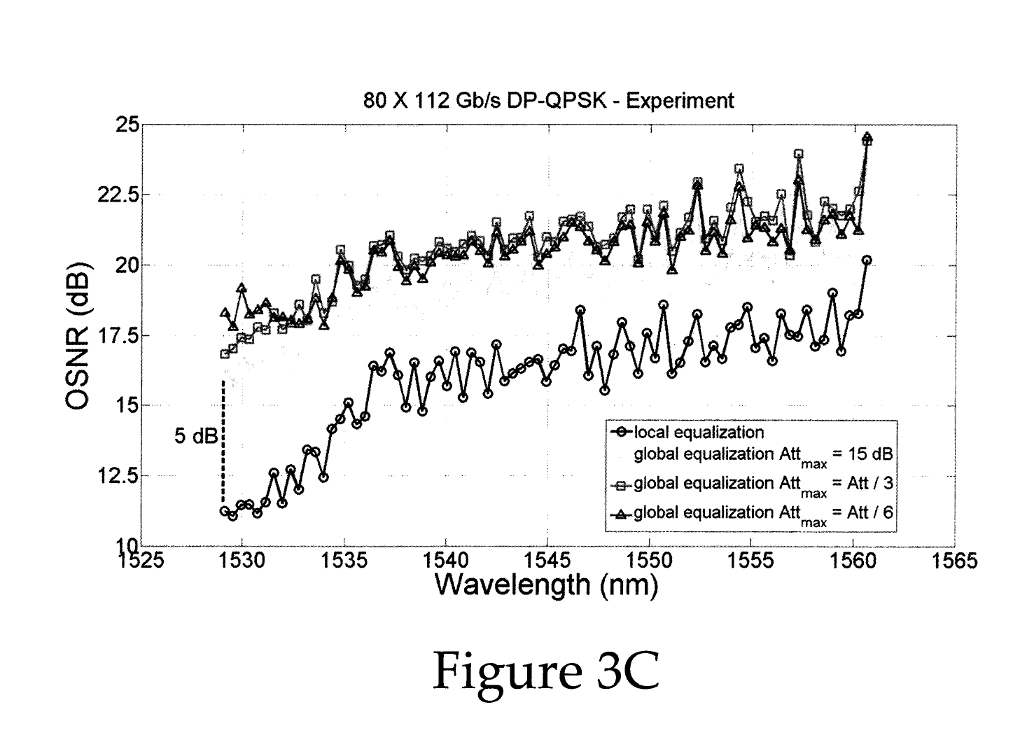

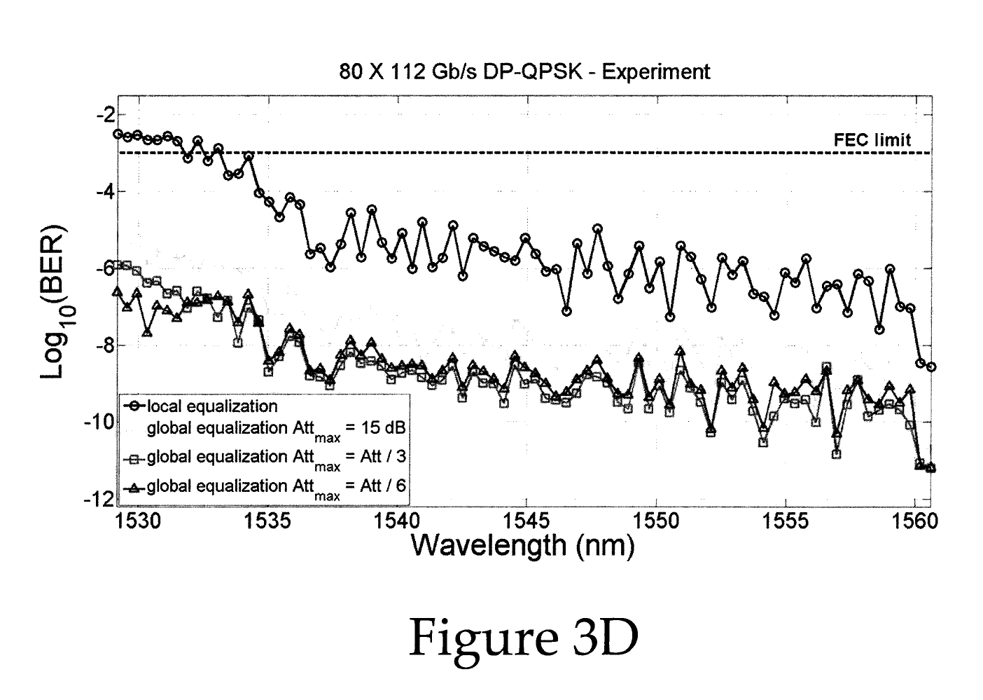

The proposed global method was compared against three attenuation thresholds per node: 15 dB per node, divided uniformly between the nodes and 50% of the total value (strategic intentional power unbalance), with practical results depicted in FIGS. 3a, 3b, 3c and 3d.

A careful and thorough reading and analysis of FIGS. 3a and 3b shows that the proposed method improves global spectral attenuation, reducing total value by approximately one third, compared against the need value for local attenuation.

OSNR analysis results, in their turn, can be seen in FIG. 3c, and bit error rate analysis results in FIG. 3d.

An analysis of the graphs will show that the proposed method achieved an OSNR gain of 5 dB for channels with shorter wavelengths, when compared against local equalization. Furthermore, when analyzing the results in FIG. 3d, one can perceive that when using the proposed method, all 80 channels are below the FEC limit.

Although this disclosure has been described in connection with certain preferred execution modalities, it is not intended to be limited to those particular modalities. To the contrary, the intention is to cover all possible alternatives, modifications and equivalences, carried out by a telecommunications engineer expert, without ever diverging from the objective outlined in this patent application, which is exclusively defined by the attached claims.

1. A global spectral equalization method, comprising:
computing, using at least one processor, a reconfigurable optical add-drop multiplexer attenuation vector sum;
computing, using the at least one processor, a residual tilt based on a level of channel warping;
computing, using the at least one processor, an unnecessary attenuation based on the attenuation vector sum and the residual tilt; and
distributing attenuation adjustment to nodes between a receiver and a transmitter based on the unnecessary attenuation.

2. The method of claim 1, further comprising normalizing the unnecessary attenuation and distributing the attenuation adjustment based on the normalized unnecessary attenuation.

3. The method of claim 1, further comprising:
applying, to a last node, a maximum attenuation allowed by a reconfigurable optical add-drop multiplexer associated with a wavelength selective switch of the last node; and
applying residual attenuation to at least one subsequent node in a direction inverse to that traveled by signal propagation.

4. The method of claim 3, wherein the last node is a node nearest to the receiver.

5. The method of claim 1, further comprising repeating the computation of the vector sum, the computation of the residual tilt, the computation of the unnecessary attenuation, and the distribution of the attenuation adjustment one or more times.

6. A global spectral equalization system, comprising:
at least one processor;
a memory including instructions that, when executed by the at least one processor, configure the processor to:
compute a reconfigurable optical add-drop multiplexer attenuation vector sum;
compute a residual tilt based on a level of channel warping;
compute an unnecessary attenuation based on the attenuation vector sum and the residual tilt; and
distribute attenuation adjustment to nodes between a receiver and a transmitter based on the unnecessary attenuation.

7. The system of claim 6, wherein the instructions, when executed by the at least one processor, further configure the processor to:
normalize the unnecessary attenuation; and
distribute the attenuation adjustment based on the normalized unnecessary attenuation.

8. The system of claim 6, wherein the instructions, when executed by the at least one processor, further configure the processor to:
apply, to a last node, a maximum attenuation allowed by a reconfigurable optical add-drop multiplexer associated with a wavelength selective switch of the last node; and
apply residual attenuation to at least one subsequent node in a direction inverse to that traveled by signal propagation.

9. The system of claim 8, wherein the last node is a node nearest to the receiver.

10. The system of claim 6, wherein the instructions, when executed by the at least one processor, further configure the processor to repeat the computation of the vector sum, the computation of the residual tilt, the computation of the unnecessary attenuation, and the distribution of the attenuation adjustment one or more times.
